(19) United States
(12) Patent Application Publication
(10) Pub. No.: US 2008/0045348 A1
(43) Pub. Date: Feb. 21, 2008

(54) Hybrid driveshaft based on unidirectional and fabric composite materials

(76) Inventor: Kum Cheol Shin, Hwaseong-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/648,880

(22) Filed: Dec. 29, 2006

(30) Foreign Application Priority Data
Aug. 18, 2006 (KR) 10-2006-0078046

(51) Int. Cl. F16C 3/00

(52) U.S. Cl. 464/181

(57) ABSTRACT

A hybrid driveshaft and method for manufacturing a hybrid driveshaft by composite materials in which an inner shaft is formed by using a unidirectional fiber reinforced composite material so as to ensure the longitudinal rigidity, a shaft middle part is formed by using a fabric fiber reinforced composite material so as to ensure the torsional rigidity and strength, and a shaft outside part is formed by using a fabric carbon fiber composite material so as to ensure the operation efficiency when performing the manufacturing operations. The hybrid structure is manufactured by using the unidirectional fiber reinforced composite material having excellent longitudinal property and the fabric fiber reinforced composite material having excellent three-dimensional property, and thus it is possible to manufacture the driveshaft having excellent specific rigidity and specific strength characteristics, having excellent noise, vibration and fatigue characteristics and having large power output.

### CROSS-REFERENCE TO RELATED APPLICATIONS

This application claims the benefit of Korean Patent Application No. 10-2006-0078046, filed on Aug. 18, 2006, in the Korean Intellectual Property Office, the disclosure of which is incorporated herein by reference.

### BACKGROUND

1. Field of the Invention

The present invention relates to a hybrid driveshaft and method for manufacturing a hybrid driveshaft for an automobile from composite materials, and more particularly, to a driveshaft and method in which an inner shaft is formed by a unidirectional fiber reinforced composite material, a shaft middle part is formed by a fabric fiber reinforced composite material having excellent three-dimensional mechanical properties, and a shaft outside part is formed by a fabric carbon fiber composite material.

2. Description of the Prior Art

Unidirectional fiber reinforced composite materials having excellent mechanical characteristics are frequently used in aircraft, and also increasingly used in the automotive field. However, with regard to fabric fiber reinforced composite materials, studies of their basic properties and their forming possibilities is being made so as for them to apply to exterior parts of an automobile.

In past studies regarding transmission of the driving force using composite materials, studies and applications regarding aircraft propeller shafts using composite materials have been made. However, no studies regarding a driveshaft using composite materials has been made.

### SUMMARY OF THE INVENTION

Embodiments of the present invention provide a hybrid driveshaft and a method for manufacturing a hybrid driveshaft using a unidirectional fiber reinforced composite material, a fabric fiber reinforced composite material and a fabric carbon fiber composite material. Such a construction makes it possible to manufacture a driveshaft having excellent vibration characteristic, improved power output and excellent performance compared to a driveshaft made of a metal material.

Further embodiments of the present invention provide a driveshaft and a method for manufacturing a driveshaft including a fabric fiber reinforced composite material having excellent specific rigidity, specific strength and mechanical characteristics, excellent noise and vibration characteristics and excellent three-dimensional mechanical property. In such a construction, an inner shaft is formed by using a unidirectional fiber reinforced composite material so as to reinforce the longitudinal rigidity and strength, a shaft middle part is formed by using a fabric fiber reinforced composite material having excellent three-dimensional properties so as to ensure the torsional rigidity and strength, and a shaft outside part is formed by using a fabric carbon fiber composite material for convenient operation by a field operator, and thus a material having lightweight and excellent rigidity and strength is used for a driving component of an automobile, thereby enabling increased fuel efficiency and improved power output.

In an exemplary embodiment of the present invention, there is provided a method for manufacturing a hybrid driveshaft for an automobile by composite materials comprising the steps of: manufacturing an inner shaft by using a unidirectional fiber reinforced composite material; forming a shaft middle part by stacking a fabric fiber reinforced composite material on the outside of the inner shaft; forming a shaft outside part by stacking a fabric carbon fiber composite material on the outside of the shaft middle part; and bonding the composite materials of respective layers to each other.

A manufacturing method according to an embodiment of the present invention may be characterized in that the inner shaft is manufactured by winding the unidirectional fiber reinforced composite material around a flat plate using a filament winding technique, hardening and cutting the same according to its size to manufacture a composite material block, and machining the composite material block in the form of a shaft by a lathe operation.

Moreover, a manufacturing method of the present invention may be characterized in that after manufacturing the inner shaft, a surface of the inner shaft is mechanically and chemically surface-treated such that the surface roughness is of from 1.2 to 1.7 μm. The inner shaft may be ground by sandpaper as the mechanical surface treatment, and then the surface of the inner shaft may be polished using acetone as the chemical surface treatment.

In a further embodiment of the present invention, the orientation angle of fibers in the unidirectional fiber reinforced composite material forming the inner shaft may be from 0 to 15 degrees so as to ensure the longitudinal rigidity and strength while reducing the thermal stress and improving the three-dimensional property. Moreover, the orientation angle of fibers in the fabric fiber reinforced composite material and the fabric carbon fiber composite material forming the shaft middle part and the shaft outside part respectively may be from 45 to 75 degrees so as to ensure the torsional strength.

In another embodiment of the present invention, the interlayer bonding of the composite materials in the step of bonding the composite materials of respective layers to each other may be carried out by a simultaneous hardening and bonding process in which the non-hardened fabric fiber reinforced composite material is stacked to form the shaft middle part, then the non-hardened fabric carbon fiber composite material is stacked to form the shaft outside part, and then the fabric fiber reinforced composite material and the fabric carbon fiber composite material are simultaneously hardened, and thus the inner shaft, the shaft middle part and the shaft outside part are bonded to each other. After the simultaneous hardening and bonding process, resin flowing out during the hardening process and forming a sharp edge on the outside surface of the shaft may be finished using sandpaper and/or a finishing tool, and thus the stress concentration may be reduced.

In a further exemplary embodiment, materials used as resins in the unidirectional and fabric fiber reinforced composite materials and the fabric carbon fiber composite material may be the same material, and thus the interlayer bonding strength may be improved and the thermal stress produced between the layers reduced.

### BRIEF DESCRIPTION OF THE DRAWINGS

The above and other objects, features and advantages of the present invention will be more apparent from the following detailed description taken in conjunction with the accompanying drawings, in which:

FIG. 1 is a side view illustrating a CV joint fitted with a hybrid driveshaft manufactured according to an embodiment of the present invention;

FIG. 2 is a cross-sectional view of a hybrid driveshaft according to an embodiment of the present invention;

FIG. 3 is a graph illustrating an example of the strength variation in accordance with the orientation angle of a unidirectional carbon fiber reinforced composite material according to embodiments of the present invention;

FIG. 4 is a graph illustrating an example of the shear strength variation in accordance with the orientation angle of a unidirectional fiber reinforced composite material according to embodiments of the present invention;

FIG. 5 is a graph illustrating an example of the strength variation in accordance with the orientation angle of a fabric fiber reinforced composite material according to embodiments of the present invention; and

FIG. 6 is a graph illustrating an example of the torsional shear strength variation in accordance with the orientation angle in case of using a fabric fiber reinforced composite material according to embodiments of the present invention.

### DETAILED DESCRIPTION OF PREFERRED EMBODIMENTS

Hereinafter, the present invention will be described in detail with reference to the accompanying drawings.

The terms to be used hereinafter are defined as follows:

(1) The term “hybrid” means that a driveshaft is formed not by one kind of material but by several kinds of materials.

(2) The term “simultaneous hardening” means that when two or more materials are bonded, a bonding process and a hardening process are performed simultaneously.

(3) The term “orientation angle,” which denotes the orientation direction of fibers contained in a composite material, is a term describing an angle inclined with respect to the reference angle.

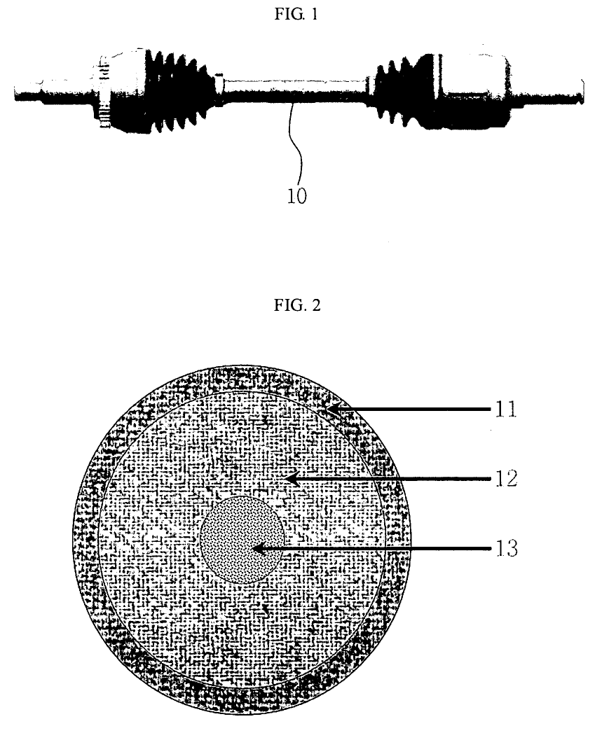

In FIG. 1, reference numeral 10 denotes a driveshaft according to one exemplary embodiment of the present invention. As the first step in the process of manufacturing a hybrid driveshaft 10 according to the present invention, an inner shaft 11 is manufactured by a unidirectional fiber reinforced composite material.

The inner shaft 11 may be formed by winding the unidirectional fiber reinforced composite material around a flat plate using a filament winding technique, hardening and cutting the same according to its size to manufacture a composite material block, and machining the composite material block in the form of a shaft by a lathe operation.

The orientation angle of fibers in the unidirectional fiber reinforced composite material may be from about 0 to 15 degrees so as to ensure the longitudinal rigidity and strength while reducing the thermal stress and improving three-dimensional property.

As a second step, a surface of the inner shaft 11 manufactured as above is chemically surface-treated such that the surface roughness may be from about 1.2 to 1.7 μm, and a fabric fiber reinforced composite material forming a shaft middle part 12 is simultaneously hardened therewith and bonded thereto, and thus better interlayer property can be attained.

The inner shaft 11 can be surface-treated by a mechanical surface treatment method using sandpaper and a chemical surface treatment method using various kinds of chemicals. It is possible to improve the bonding strength by carrying out the chemical surface treatment after the mechanical surface treatment.

As the third step, the shaft middle part 12 may be formed by stacking a non-hardened fabric fiber reinforced composite material on the outside of the inner shaft 11 manufactured by the unidirectional fiber reinforced composite material in accordance with size and thickness thereof. The orientation angle of the fabric fiber reinforced composite material may be determined, and then it is stacked.

A preferred orientation angle of fibers contained in the fabric fiber reinforced composite material forming the shaft middle part 12 is from about 45 to 75 degrees so as to ensure the torsional strength.

As a fourth step, after surface-treating the shaft middle part 12, a non-hardened fabric carbon fiber composite material may be stacked on the outside of the shaft middle part at an orientation angle of about 45 to 75 degrees so as to ensure the torsional strength, and thus a shaft outside part 13 is formed.

As a fifth step, after sequentially stacking the fabric fiber reinforced composite material and the fabric carbon fiber composite material, the fabric fiber reinforced composite material of the shaft middle part 12 and the fabric carbon fiber composite material of the shaft outside part 13 may be simultaneously hardened and bonded. If simultaneous hardening and bonding process is carried out, then the composite materials of respective layers including the unidirectional fiber reinforced composite material of the inner shaft 11 are bonded to each other.

During the simultaneous hardening and bonding process, care about preventing contamination of a bonding surface must be taken, and the bonding surface should be temporarily bonded as soon as possible so that moisture of the air cannot influence thereon.

After the final hardening and bonding of the hybrid driveshaft, resin that flows out during the hardening process and forms a sharp edge on the outside surface of the shaft may be finished using sandpaper and/or a finishing tool, thereby enabling the stress concentration to be reduced.

According to embodiments of the present invention, materials used as resins in the unidirectional and fabric fiber reinforced composite materials and the fabric carbon fiber composite material may be the same material, and thus the interlayer bonding strength can be improved and the thermal stress produced between the layers can be reduced.

Exemplary embodiments of the present invention, including examples of specific materials, are described below for illustrative purposes only. Those skilled in the art will appreciate that the scope of the present invention is not limited by these exemplary embodiments.

In one example of the present invention, components and manufacturing method of fibers and resins constituting the unidirectional and fabric fiber reinforced composite materials are as follows:

(1) Unidirectional carbon fiber composite material:
1. Manufacturing company: SK Chemicals
2. Product name: USN150BX Prepreg (thickness: 0.144 mm; mass: 224 g/m²)
3. Component ratio: 150 g/m² (fiber), 36 g/m² (resin)
4. Kind of fiber: carbon fiber
5. Kind of resin: epoxy resin (Bisphenol A)

(2) Unidirectional glass fiber composite material:
1. Manufacturing company: SK Chemicals
2. Product name: UGN150 Prepreg (thickness: 0.122 mm; mass: 224 g/m²)
3. Component ratio: 150 g/m² (fiber), 33 g/m² (resin)
4. Kind of fiber: glass fiber
5. Kind of resin: epoxy resin (Bisphenol A)

(3) Fabric glass fiber composite material:
1. Manufacturing company: HANKUK FIBER CO., LTD.
2. Product name: HG181/RS1222 (thickness: 0.25 mm; mass: 299 g/m²)
3. Kind of fiber: glass fiber
4. Kind of resin: epoxy resin

(4) Fabric carbon fiber composite material:
1. Kind of Product: UCFRP fabric with roving containing 12,000 filaments (160 g/m²)
2. Characteristic of components: 181 g/m² (fiber), 130 g/m² (resin)
3. Kind of fiber: T800H carbon fiber (Toray Industries Inc.)
4. Kind of resin: Biocompatible epoxy resin (MAN Ceramics Company)

In order to measure the torsional strength of the composite material shaft, Instron Universal Testing Machine and MTS (Materials Testing Systems) were used (bonding strength [Pa]=maximum load [N]/cross sectional area of a joint bonding surface [m²]).

According to the present invention, a method for improving the shear strength of the hybrid driveshaft takes into account that (A) the orientation angle of the unidirectional fiber reinforced composite material used for the inner shaft 11 and (B) the orientation angle of fibers in the fabric fiber reinforced composite material and the fabric carbon fiber composite material used for the shaft middle part 12 and the shaft outside part 13 respectively. The orientation angle of the unidirectional fiber reinforced composite material used for the inner shaft 11 may be determined as follows:

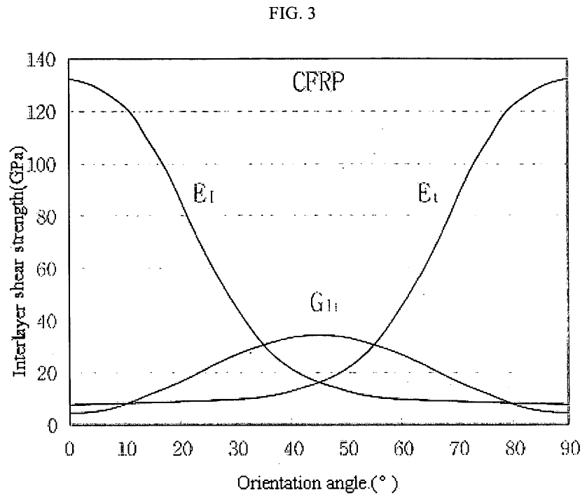

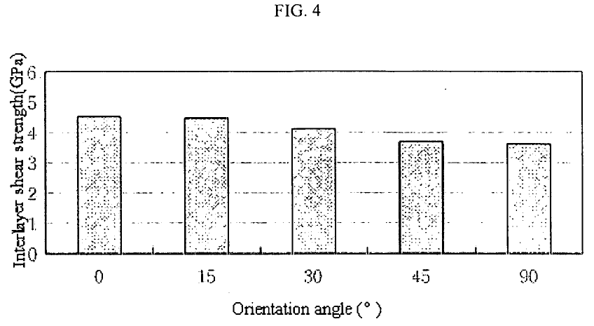

FIG. 3 is a view illustrating the strength variation in accordance with the orientation angle of fibers in the unidirectional carbon fiber reinforced composite material, and FIG. 4 is a view illustrating the interlayer shear strength by which the torsional shear strength of the shaft can be expected. As can be seen from two drawings, an orientation angle for reinforcing the longitudinal strength and ensuring the torsional strength is from bout 0 to 15 degrees.

The orientation angle of the fabric fiber reinforced composite material and the fabric carbon fiber composite material used for the shaft middle part 12 and the shaft outside part 13 may be determined as follows:

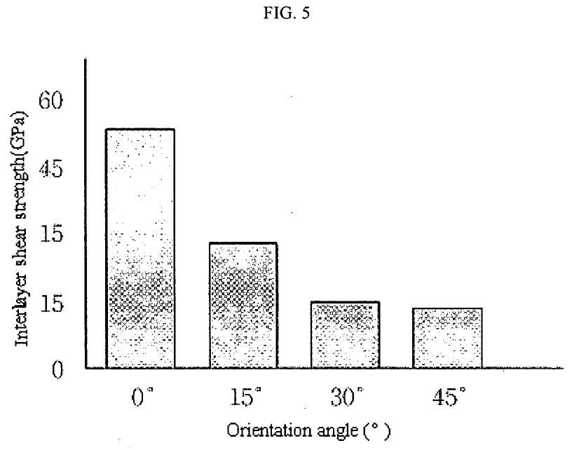

FIG. 5 is a view illustrating the strength variation in accordance with the orientation angle of the fabric fiber reinforced composite material, in which the strength decreases as the orientation angle increases. However, since the torsional rigidity and strength is irrespective of a design for the longitudinal rigidity in manufacturing the driveshaft, it is not necessary to take into account the result illustrated in FIG. 5.

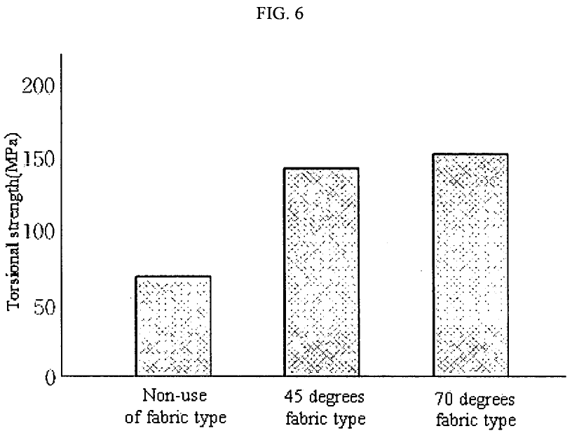

However, as can be seen from FIG. 6 illustrating the torsional strength variation of the fabric fiber reinforced composite material, the torsional strength increases as the orientation angle of fibers increases, and the orientation angle may be determined in the range of about 45 to 75 degrees.

According to a manufacturing method of the present invention, it is possible to manufacture by differing the materials of the unidirectional and fabric fiber reinforced composite materials from each other. For example, even when the hybrid driveshaft is to be manufactured by mixing the unidirectional and fabric fiber composite materials and the carbon fiber composite material, if the hybrid driveshaft is manufactured according to the above manufacturing method, then excellent performance can be attained.

As described above, according to the method for manufacturing the hybrid driveshaft by using the composite materials of the present invention, the hybrid structure is manufactured by using the unidirectional fiber reinforced composite material having excellent longitudinal property and the fabric fiber reinforced composite material having excellent three-dimensional property, and thus it is possible to manufacture the driveshaft having excellent specific rigidity and specific strength characteristics, having excellent noise, vibration and fatigue characteristics and having large power output.

Moreover, according to a manufacturing method of the present invention, there is an advantageous effect in that it is possible to adjust vibration and power output characteristics in case of adjusting the orientation angle of fibers in the composite materials used, and better fuel efficiency characteristic can be attained because the weight of the composite materials is lighter than that of the conventional materials.

Furthermore, according to the present invention, a condition can be given that enables, in addition to the driveshaft, a propeller shaft for transmitting the driving force in an automobile to be further developed based on the present invention, and the present invention can be applied to the manufacturing method of components manufactured based on the torsional rigidity and strength in addition to the components for transmitting the driving force.

Although preferred embodiments of the present invention have been described for illustrative purposes, those skilled in the art will appreciate that various modifications and changes thereof are possible without departing from the scope and spirit of the present invention, and all modifications and changes are intended to be included within the description of the claims.

What is claimed is:

1. A method for manufacturing a hybrid driveshaft for an automobile from composite materials, comprising:
manufacturing an inner shaft using a unidirectional fiber reinforced composite material;
forming a shaft middle part by stacking a fabric fiber reinforced composite material on an outside of the inner shaft;
forming a shaft outside part by stacking a fabric carbon fiber composite material on an outside of the shaft middle part; and
bonding the composite materials of respective layers to each other.

2. The method for manufacturing a hybrid driveshaft for an automobile by composite materials as claimed in claim 1, wherein the inner shaft is manufactured by winding the unidirectional fiber reinforced composite material around a flat plate using a filament winding technique, hardening and cutting the same according to its size to manufacture a composite material block, and machining the composite material block in the form of a shaft by a lathe operation.

3. The method for manufacturing a hybrid driveshaft for an automobile by composite materials as claimed in claim 1 or 2, wherein after manufacturing the inner shaft, a surface of the inner shaft is mechanically and chemically surface-treated such that the surface roughness is of from 1.2 to 1.7 μm.

4. The method for manufacturing a hybrid driveshaft for an automobile by composite materials as claimed in claim 3, wherein the inner shaft is ground by sandpaper as mechanical surface treatment, and then the surface of the inner shaft is polished using acetone as the chemical surface treatment.

5. The method for manufacturing a hybrid driveshaft for an automobile by composite materials as claimed in claim 1, wherein the orientation angle of fibers in the unidirectional fiber reinforced composite material forming the inner shaft is of from about 0 to 15 degrees.

6. The method for manufacturing a hybrid driveshaft for an automobile by composite materials as claimed in claim 1, wherein the orientation angle of fibers in the fabric fiber reinforced composite material and the fabric carbon fiber composite material forming the shaft middle part and the shaft outside part respectively is from about 45 to 75 degrees.

7. The method for manufacturing a hybrid driveshaft for an automobile by composite materials as claimed in claim 1, wherein the interlayer bonding of the composite materials in the step of bonding the composite materials of respective layers to each other is carried out by a simultaneous hardening and bonding process in which the non-hardened fabric fiber reinforced composite material is stacked to form the shaft middle part, then the non-hardened fabric carbon fiber composite material is stacked to form the shaft outside part, and then the fabric fiber reinforced composite material and the fabric carbon fiber composite material is simultaneously hardened, and thus the inner shaft, the shaft middle part and the shaft outside part are bonded to each other.

8. The method for manufacturing a hybrid driveshaft for an automobile by composite materials as claimed in claim 7, wherein after the simultaneous hardening and bonding process, a resin flowing out during the hardening process and forming a sharp edge on the outside surface of the shaft is finished using sandpaper and a finishing tool, and thus stress concentration is reduced.

9. The method for manufacturing a hybrid driveshaft for an automobile by composite materials as claimed in claim 1 or 7, wherein materials used as resins in the unidirectional and fabric fiber reinforced composite materials and the fabric carbon fiber composite material are the same material, and thus interlayer bonding strength is improved and thermal stress produced between the layers is reduced.

10. A hybrid driveshaft for an automobile, comprising:
an inner shaft comprising a unidirectional fiber reinforced composite material;
a shaft middle part disposed on an outside of the inner shaft and comprising a fabric fiber reinforced composite material;
a shaft outside part disposed on an outside of the shaft middle part and comprising a fabric carbon fiber composite material;
wherein the composite materials of respective layers are bonded to each other.

11. The hybrid driveshaft as claimed in claim 10, wherein the inner shaft is manufactured by winding the unidirectional fiber reinforced composite material around a flat plate using a filament winding technique, hardening and cutting the same according to its size to manufacture a composite material block, and machining the composite material block in the form of a shaft by a lathe operation.

12. The hybrid driveshaft as claimed in claim 10, wherein the orientation angle of fibers in the unidirectional fiber reinforced composite material forming the inner shaft is from about 0 to 15 degrees.

13. The hybrid driveshaft as claimed in claim 10, wherein the orientation angle of fibers in the fabric fiber reinforced composite material and the fabric carbon fiber composite material forming the shaft middle part and the shaft outside part respectively is from about 45 to 75 degrees.

14. The hybrid driveshaft as claimed in claim 10, wherein bonding the composite materials of respective layers to each other is carried out by a simultaneous hardening and bonding process in which the non-hardened fabric fiber reinforced composite material is stacked to form the shaft middle part, then the non-hardened fabric carbon fiber composite material is stacked to form the shaft outside part, and then the fabric fiber reinforced composite material and the fabric carbon fiber composite material is simultaneously hardened, and thus the inner shaft, the shaft middle part and the shaft outside part are bonded to each other.

15. The hybrid driveshaft as claimed in claim 10, wherein materials used as resins in the unidirectional and fabric fiber reinforced composite materials and the fabric carbon fiber composite material are the same material, and thus interlayer bonding strength is improved and thermal stress produced between the layers is reduced.
